(19) United States
(12) Patent Application Publication
(10) Pub. No.: US 2002/0066074 A1
(43) Pub. Date: May 30, 2002

(54) Method and system for developing and executing software applications at an abstract design level

(76) Inventor: Mohamed I. Jabri, Plano, TX (US)

Correspondence Address: David L. McCombs, HAYNES AND BOONE LLP, Suite 3100, 901 Main Street, Dallas, TX, 75202-3789, US

(21) Appl. No.: 09/873,830

(22) Filed: Jun. 4, 2001

Related U.S. Application Data
(60) Provisional application No. 60/209,698, filed on Jun. 5, 2000.

(51) Int. Cl. G06F 9/44; G06F 9/45

(52) U.S. Cl. 717/105; 717/108; 717/109; 717/136

(57) ABSTRACT

A method and system for developing and executing applications at an abstract design level is disclosed. In a preferred embodiment of the present invention, a visual modeling or assembly tool is used to capture application logic, independently from the underlying technologies and hardware and software infrastructure, and to deploy it onto an execution platform dynamically. The execution platform is responsible for providing access to a variety types of external client devices to execute the application logic and receive responses in formats suitable for the external client devices.

### CROSS REFERENCE

This application claims the benefit of the U.S. Provisional Patent Application Serial No. 60/209,698, which was filed on Jun. 5, 2000.

### BACKGROUND OF THE INVENTION

The present invention relates generally to data processing, and more particularly, to a system and method for software application development and deployment in enterprise, Internet, and mobile environment.

In the e-commerce world, information technologies are on the critical path of a company's success. Business needs are in a constant state of change, and require highly skilled professionals to constantly develop business applications. However, most of today's applications fall short in meeting user's expectations and needs, thus creating high demand for new application development. On the other hand, current application development platforms and practices are time consuming, costly, labor-intensive, and too inflexible to respond to this increased demand. Particularly for developing e-business applications today, projects range from 3 months to 2 years and involve from ten to hundreds of project managers, system analysts, designers, architects, developers, web designers, and database administrators. What starts as a concept, or a business need, can quickly mushroom into a multi person-year effort, with low odds of success. Examining today's software development processes reveals that translating the understanding of the application objectives and features into a working implementation consumes a lot of manual labor, which crosses many team members with varying skill sets. In addition, both software development technologies and tools are still geared toward low-level programming. Even coding simple and common functionality in an e-business application requires a multitude of technology skill sets and a significant amount of manual effort, which in turn, creates more room for errors, debugging and rework. Another observation worth mentioning is that application developers are tasked with securing end-user consensus/compromises in order to build an application that satisfies all involved parties. This task is traditionally difficult and time consuming, and results in poor end-user experience.

What is lacking is a common platform for developing business applications that address immediate needs of any business sector, integrating various business applications with customer specific enterprise systems, and extending applications functionality to the Internet. A method and system is needed for validating functionality of a new application, generating required databases schema and object mapping to complete the application, and integrating the new application with existing enterprise systems.

### SUMMARY OF THE INVENTION

A method and system for developing and executing applications at an abstract design level is disclosed. In one embodiment of the present invention, a visual modeling or assembly tool is used to capture application logic, independently from the underlying technologies and hardware and software infrastructure, and to deploy it onto an execution platform dynamically. The execution platform is responsible for providing access to a variety types of external client devices to execute the application logic and receive responses in formats suitable for the external client devices.

The benefit of the present invention is significant to almost all businesses. With such a platform for building and running large scale enterprise and Internet ready business machines or systems, the business users are empowered to make business process automation in integral part of their day-to-day business. For example, business analysts can develop fully functional systems by simply capturing a business logic. With the support of this system, traditional businesses can refocus on their respective core competencies instead of focusing on new computer programming technologies. Thus, they will enjoy a more efficient business operation, establish a business model more responsive to market demands, and accomplish an exponential growth in the e-commerce market.

### BRIEF DESCRIPTION OF THE DRAWINGS

FIG. 1 illustrates a graphical environment of a visual modeling tool according to one example of the present invention.

FIG. 2 is a dialog box that captures general object properties about a selected object according to one example of the present invention.

FIG. 3 is a dialog box for capturing and showing attributes of the selected object of FIG. 2.

FIG. 4 is dialog box showing the relationship parameters the selected object of FIG. 2.

FIG. 5 is a dialog box that captures information about a selected object attribute according to one example of the present invention.

FIG. 6 is a dialog box that captures information about a particular object relationship according to one example of the present invention.

FIG. 7 is a process editor for capturing a high-level structure according to one example of the present invention.

FIG. 8 illustrates an execution platform according to one example of the present invention.

### DESCRIPTION OF THE PREFERRED EMBODIMENT

The present invention now will be described more fully hereinafter with reference to the accompanying drawings and attachments, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

For illustration purposes only, various embodiments of the present invention may be referred to summarily as a Virtual Enterprise (VE) system. The VE system has been developed with the following key underlying principle: innovating in the process of developing e-business applications by concentrating on simplicity and automation, while leveraging sound software engineering practices, and conforming to open standards, thereby empowering the end-users in developing their programming. Various middleware can be used seamlessly with the VE system, and many of the application development activities are now transformed into end-user personalization.

The VE system provides a method and system for providing a common platform that would meet long felt business needs to develop business applications, blend the developed applications into existing enterprise systems of choice, and leverage the Internet technology to extend the application functionality. The VE system is business user oriented and integrates disparate systems into one common platform. It is a software platform for rapid development and integration of enterprise systems. More specifically, it validates functionality of a new application in a quick turn-around time, generates required database scheme and object mapping to complete the application, and integrates the new application seamlessly with existing enterprise systems. Therefore, the VE platform offers full Business-to-Customer and Business-to-Business support with no additional effort.

By examining computer programs, and especially business applications, it is discovered that all applications are made of two types of code: code that captures the application logic, and code that interfaces the application logic with external entities. A sample Java program shown below is a simple implementation of a predetermined application logic to print the result of 2 plus 2 to the command shell,

Public class TwoPlusTwo

public static void main (Strings args[ ])

System.out.printLn (2+2);

It is noted that in this example, the application logic code is simply “2+2,” and all the rest is the interface code. Obviously, the percentage of the interface code is predominantly larger than the application logic code. Since end-users use applications for the application logic, not the interface or language/API, hence, from the perspective of the users, the interface and language/API code is pure overhead and is a direct consequence of the underlying technologies. It is further noted that the application logic in business systems interact with several external entities, however, users and databases make up the majority of these external entities. Large-scale applications tend to interact with various types of external entities (e.g. LDAP, file system, middleware services like transaction management and security, other applications), which make them more difficult to develop. E-business applications tend to interact with even a larger set of external entities. For example, the requirement for access anywhere anytime translates to a multitude of interface code to support HTML, DHTML, WAP, VoiceXML, Web Services, and more other devices. Since the Application logic tends to be declarative by nature, and thus the so called 3^{rd} Generation Languages (e.g. C++, Java) are not the most suitable form for capturing or maintaining the application logic. As a result, the more external entities to interact with, the more language/API's to for the programmers/companies to learn, use, and staff up for, resulting in an exponentially greater development time, cost, and risks.

What is contemplated by the present invention a method and system for developing and executing applications at an abstract design level while effectively separating the application logic from the interface logic. As mentioned above, every software mainly includes two main groups of functionality: the first group consists of the intended application logic that the software is built to perform, and the second group is all the logic necessary for the software to interface with external entities. For example, a simple client/server application would contain the necessary logic to perform the intended functionality, a set of logic to facilitate user interaction, and a set of logic to interact with a database to maintain persistent data. The VE system provides a software platform where the intended application logic for a new software can be captured by non-programmers, and would be used to develop a fully functional software product. The VE system simplifies the process of capturing and expressing the application logic, automates/pre-builds all necessary logic for interfacing with external entities such as communication devices or databases, and executes the application logic dynamically from an execution platform.

In one example of the present invention, a visual modeling or assembly tool is used to capture the application logic, independently from the underlying technologies and hardware and software infrastructure. The visual modeling tool can deploy the captured application logic onto an execution platform dynamically. The execution platform is responsible for providing access to a variety types of external client devices to execute the application logic and receive responses in formats suitable for the external client devices.

Visual Modeling Tool

As stated above, while developing a software application, the visual modeling tool is used to capture application logic at an abstract design level, and then to deploy the captured application logic onto an execution platform.

The visual modeling tool can be implemented in many ways, ranging from a series of programs executable from a command shell to an integrated graphical environment to handle all aspects of the design and deployment. The later is the preferred implementation, and is further discussed below.

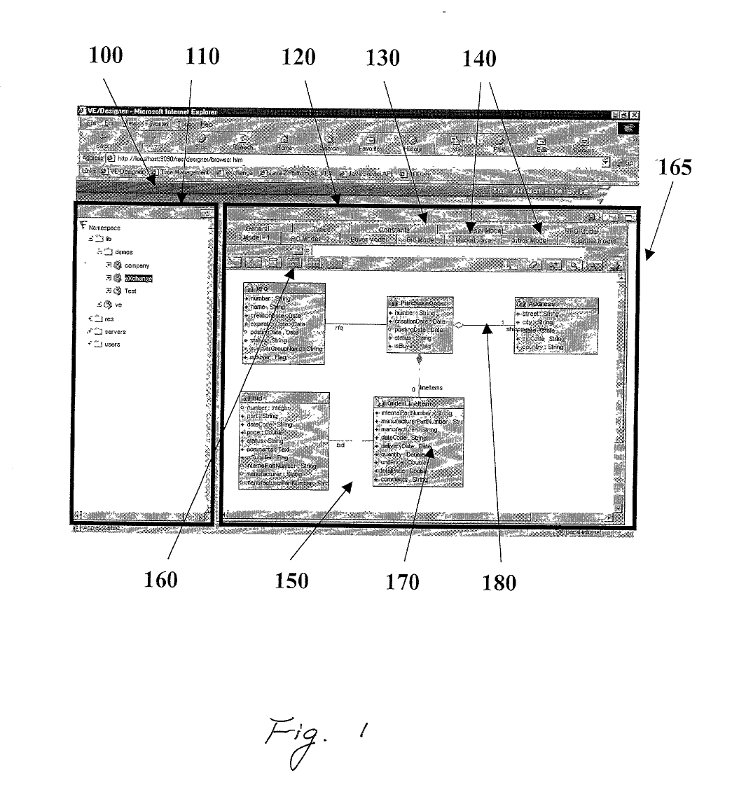

FIG. 1 illustrates a graphical environment 100 containing an organization panel 110 for organizing various parts of the application logic, namely, object definitions, and high-level structures (e.g. processes, rules, spreadsheets, neural networks), grouped into packages. In addition, the graphical environment 100 contains an object panel 120 to host the appropriate object editor based on the selected object in the organization panel 110.

Upon selecting a package object in the organization panel 110, a package editor 130 is displayed in the object panel 120. The package editor 130 contains multiple tabs 140 for capturing package related information like name, domain, description, and dependency on other packages. In addition, the package editor 130 contains tabs 140 for capturing object definitions into object models, constants, and types. Although the following description of the present invention uses a Universal Modeling Language (UML) notation for visually capturing object definitions, it is understood that the format or the notation of such object definitions may vary significantly (for example, Object Model techniques (OMT), Extended Markup Language Schema (XML Schema), Web Service Definition Language (WSDL), etc.).

The object modeler 150 provides a tool bar 160 for creating new objects and relationships. It also provides a panel 165 for visualizing the created objects and their interrelationships. According to the UML notation, each object is represented by a rectangle 170, which contains the name of the object, a list of attributes, and a list of operations (object behavior). A relationship between two objects is represented by a line 180, along with a label that specifies the name of the relationship. Additional visual marks help to specify the relationship type, direction, and cardinality.

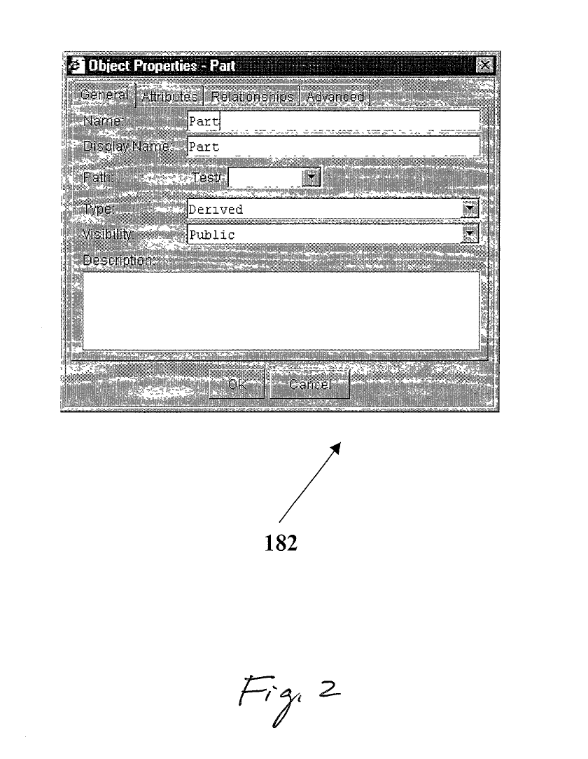

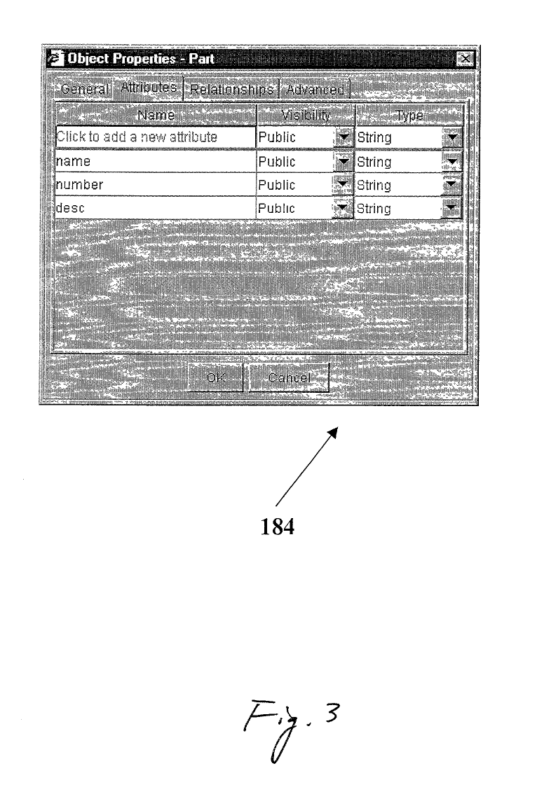

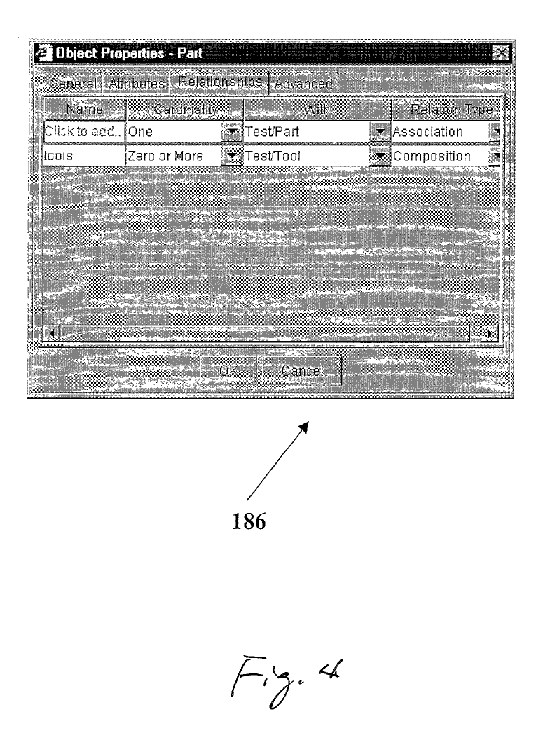

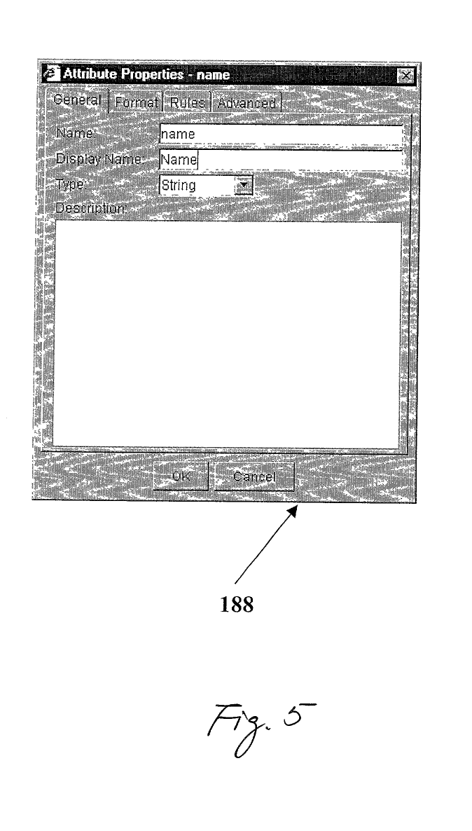

FIG. 2 is a dialog box 182 that captures general object properties about a selected object. The object properties, for example, may include name, package, path, display name, and description, etc. FIG. 3 illustrates a dialog box 184 showing attributes of the selected object of FIG. 2, where a user of the VE system can view, add, or delete object attributes. FIG. 4 illustrates another dialog box 186 showing relationship. The selected object has, where the user can view, add, or delete relationship parameters. FIG. 5 illustrates a dialog box 188 that captures information about a particular object attribute. This may include the name, display name, type, and description of the attribute. The type of the attribute can be one of predefined primitive types (e.g. string, integer, float, date), or a custom type that is based on another primitive or custom type. The available custom types include ones defined under a package custom types tab, or in any of its prerequisite packages. Further, one can associate rules, in the form of formulas, with an attribute (e.g. value constraints, default value, value domain).

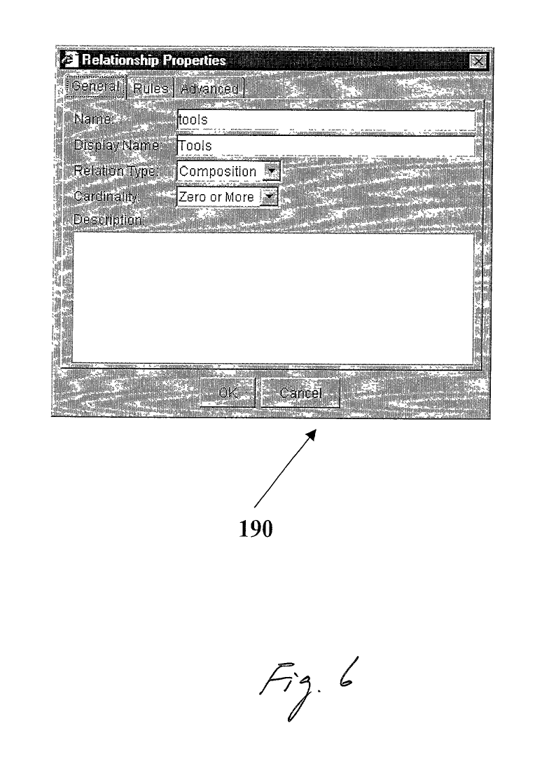

FIG. 6 illustrates a dialog box 190 that captures information about a particular object relationship. This may include the name, display name, type, cardinality, and description parameters. The type parameter is dependent of the notation, and in this case, it can be aggregation, composition, or association. The cardinality parameter is also dependent on the notation, in this case, one, zero-or-one, zero-or-more, or one-or-more. Further, one can associate rules, in the form of formulas, with a relationship (e.g. value constraints, default value, value domain). Relationship can be either unidirectional or bi-directional. In a bi-directional relationship, the relationship information for each direction may need to be defined.

For object-oriented computer programming technologies, objects can be “specialized” from other objects. Hence, an inheritance relationship may be required. In addition, objects can have behavior information. The behavior information can be defined in the form of formulas organized in a variety of high-level structures (e.g. processes, rules, spreadsheets, neural networks).

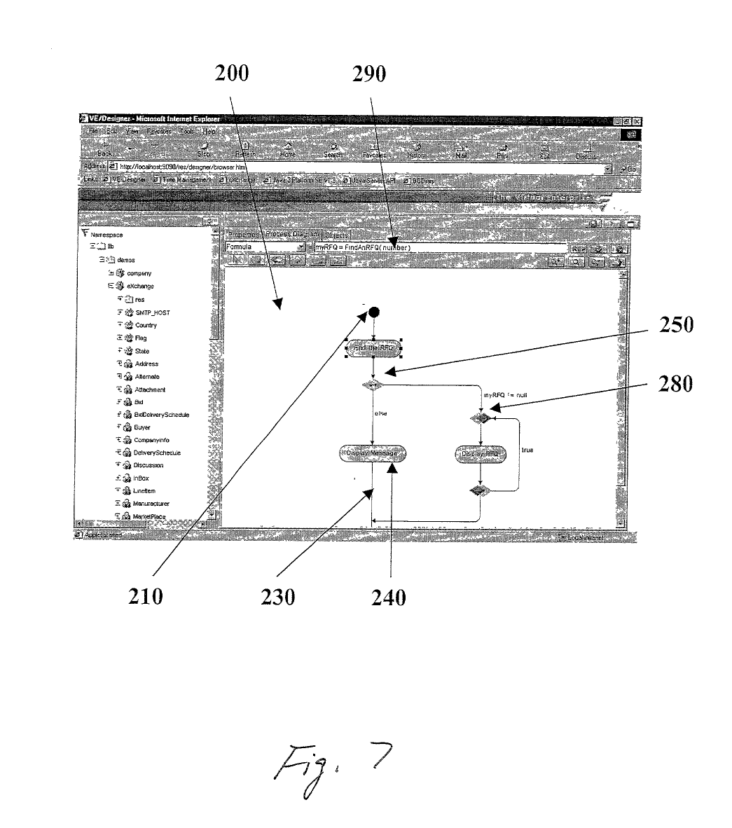

FIG. 7 illustrates a process editor 200 for capturing a high-level structure (e.g., a process). Again, the UML notation is used to capture a process in an activity diagram. A process has a beginning 210, and an end 220, and at least one thread 230 of execution (or transition). Between the beginning 210 and end 220, one or more activities 240, decisions 250, forks 260, states 270, and loops 280 govern the sequence of the execution of the process, thus indirectly control the desired application logic. Each activity specifies an appropriate formula 290 to be executed. In addition, decisions, loops, and states also use formulas to specify desired execution behaviors. Once the application logic is captured, it will be saved directly to an execution platform. In addition, the visual modeling tool provides a mechanism to deploy the captured application logic onto an execution platform. The process of deployment includes persisting the application logic on the execution platform, and generating the appropriate storage system schemas to house persistent objects. The format of the generated schemas depends on the type of the storage device (e.g. relational schema and object-to-relational mapping for relational databases).

Execution Platform

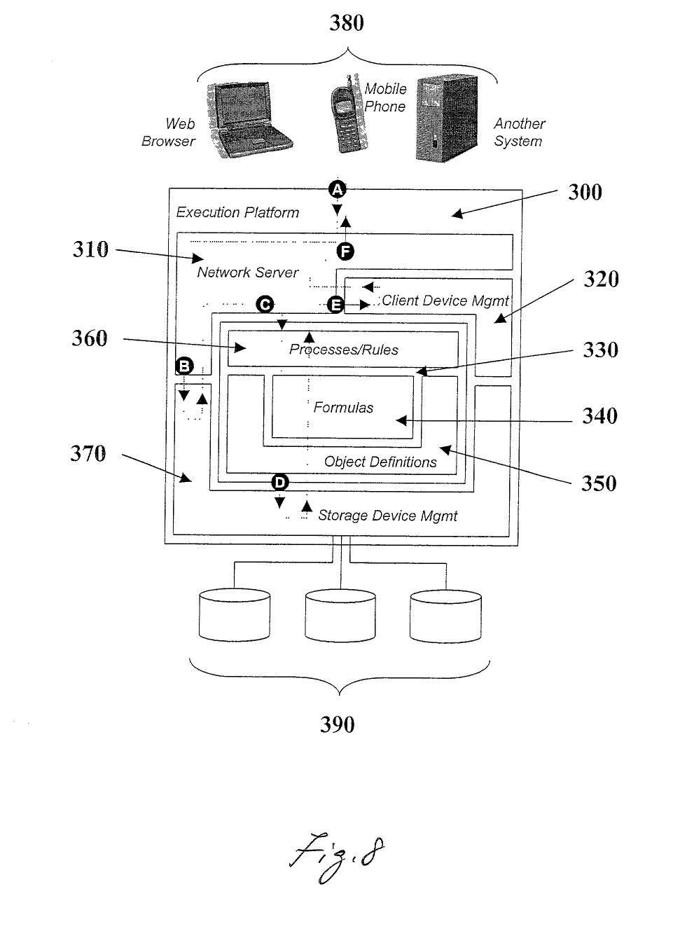

FIG. 8 graphically illustrates an execution platform 300 for the VE system. The execution platform is responsible for hosting the application logic (e.g., formulas 340, object definitions 350, and high-level constructs 360 such as processes, rules, spreadsheets, neural networks). Further, the execution platform 300 is responsible for providing access to external client devices 380 to submit an external request for executing application logic and receiving a response in a format appropriate to the external client device 380. The external client device can be a web browser, a WAP phone, a PDA, or a device implemented with voice XML technologies. It is also contemplated that another system using web servers can also be communicating with the execution platform. Listening, receiving, and responding to external requests are the responsibilities of the network server 310 (e.g. HTTP, RPC, CORBA, DCOM server) subsystem. A storage device management subsystem 370 of the execution platform 300 may also interact with different storage device schemas in one or more storage devices 390 such as a database, an LDAP, or a file system. The storage device schemas are databases, columns, rows, or other entities used for storing information in a storage device, and they are created after the application logic is captured and for implementing the application logic.

For the purposes of illustration, an execution process is graphically depicted with highlighted routes through various components or entities within or outside the VE system. Therefore, a process step may be labeled by letters A-F. For instance, upon receiving an external request from an external client device 380 (A), the network server 310 loads a predetermined or captured application logic from the storage device management subsystem 370 (B). The external request may contain various parameters. In order to pass these parameters to the application logic, they may need to be converted to an appropriate format. The storage device management subsystem 370 is responsible for communicating to the storage devices 390, caching read data, converting read data to objects, and writing objects as data in the appropriate format for the storage device accordingly with a predetermined object-to-data schema and mapping.

The network server 310 then uses an execution engine 330 to invoke the application logic (C). The execution engine 330 is responsible for executing formulas 340 and higher-level constructs 360 and maintaining the state of the execution in objects (accordingly with the object definitions 350) and execution stack. The execution engine 330 can be implemented in several ways including interpreted, just-in-time compiled, and compiled application logic.

In the process of executing application logic, formulas can trigger processes for accessing, updating data in corresponding storage device schemas. Hence, one or more requests (D) to the storage device management subsystem 370 are made to retrieve or update objects or other entities of the appropriate storage devices.

Upon completing the execution of the application logic, the execution engine 330 will respond to the network server 310 with an execution response object. The network server 310 will use a client device management subsystem 320 for converting the response object to the appropriate format (E). Taking into consideration the external client device 380 type (e.g. Internet Explorer, Netscape, WAP phone, SOAP client), version, accepted mime types, and locale information, the client device management subsystem 320 is responsible for maintaining format information (“skins”) for each object definition 350, deciding which content handler to use to convert a given object into an appropriate skin, and using a content handler to convert an object to a format suitable for the external client device 380. The network server 310 will then respond to the external client device request with the appropriately formatted response (F).

Custom plugs can be developed to connect any proprietary systems to the VE system. In some examples, developed software plugs can be used to integrate prepackaged CORBA-based, or EJB-based solutions. Additionally, any application developed based on the VE system is Internet enabled by making a predetermined server for the application visible through an established firewall. The access can also be controlled by installing some appropriate control mechanisms at the firewall. The VE system can also use the JAVA Messaging Service for communicating with industry proven message queuing and event publish/subscribe products. Using the state of art technologies for the e-commerce solutions, various Internet standards such as XML, XSL, HTTP, HTTPS are included or used by the VE system. For maintaining network security, well known protocols or standards such as SSL, X.509 digital certificates, and ACL can also be integrated therein.

Pause/Resume Operation

Software application developed by the VE system also supports a Pause/Resume operation which provides a mechanism to pause computer processing in a particular activity in order to get input from the process originator—client (such as the end user). This capability can be extended through an application providing unique mechanisms for a conversational client/server application.

During the process flow of a particular activity, it may be necessary to retrieve information from a source external to the currently running process. Using a method or function call, the process will try to retrieve this information. The process flow may then be paused in order to begin a new process flow to retrieve the information from the process originator. After retrieving the information, the original process then resumes its flow as normal.

In a web-based application, the typical way of retrieving information from the user is on a page-by-page basis. This tends to significantly complicate the implementation of the software application by breaking down logical flows into disjoint chunks of logic spread out and embedded in several web pages. In addition, session state management is both manual and difficult. However, with the pause/resume mechanism, one can insert read functions as steps in well coherent and logical to retrieve additional information from the user. Once the execution engine encounters each read, it will pause execution, serve the object to be read/updated to the user, and waits until the user completes the task and resume processing. On resumption, the execution engine rebuilds the execution stack to where it left of, and continues execution of the subsequent steps. The execution engine also maintains intermediate stack states to support the Back button available on most browsers.

For example, a form for creating a new user may initially include input parameters for “First name” and “Last name”. If later during the process it is determined that more information is needed, such as address information, a new web page is presented to the user for retrieval of the new information, such as “Street”, “City”, “State” and “Zip”. It is also possible to provide the same input mechanism for a different scenario, such as adding a new vendor, in which case perhaps inputs would be initially, “Business name”, “Contact” and “Phone number”. Subsequently, the address information can be added as needed using the exact same mechanism as described above.

In summary, the VE system provides a framework for separating the interface code from the application logic to ease the development of a business software. This facilitates the customization of the interface code to support current and future types of external entities, independent from the customized development of the application logic. The VE system also provides visual modeling tools that comply with industry standard notation to specialize the application logic side of the framework into business applications, while completely eliminating the low-level coding and required technology skill sets, and allowing the end-user directly interacts with and manipulates modeled objects. The VE system blurs the line between development time and runtime, thus providing the end-user with customization and personalization tools, and hence, shifting some of the development activities from the application developer to the end-user.

The benefit of having this VE system is significant to almost all businesses. With such a platform for building and running large scale enterprise and Internet ready business machines or systems, the business users are empowered to make business process automation in integral part of their day-to-day business. For example, business analysts can develop fully functional systems by simply capturing a business logic. With the support of this VE system, traditional businesses can refocus on their respective core competencies instead of being stressed over new computer programming technologies. Thus, they will enjoy a more efficient business operation, establish a business model more responsive to market demands, and accomplish an exponential growth in the e-commerce market.

While the invention has been particularly shown and described with reference to the preferred embodiment thereof, it will be understood by those skilled in the art that various changes in form and detail may be made therein without departing from the spirit and scope of the invention, as set forth in the following claims.

What is claimed is:

1. A method for developing and executing software applications at an abstract design level, the method comprising:
capturing an application logic at the abstract design level as one or more visual models for developing a software application, the visual models being independent from an underlying programming technology;
deploying the captured application logic to an execution platform;
executing the application logic from the execution platform in response to an external request sent by an external client device, the external request having one or more parameters;
processing the external request;
returning one or more response objects after processing the external request; and
presenting the converted response objects to the external client device.

2. The method of claim 1 wherein the step of processing further includes converting the parameters of the external request to one or more objects and passing the converted parameters to the application logic.

3. The method of claim 1 wherein the step of presenting further includes converting the response objects to a predetermined format based on a type of the external client device or the parameters of the external request.

4. The method of claim 1 wherein the step of capturing further includes generating one or more storage device schemas in at least one storage device as required by the captured application logic.

5. The method of claim 1 wherein the step of deploying further includes saving the captured application logic to the execution platform.

6. The method of claim 1 wherein the step of executing further includes:
retrieving one or more objects from at least one storage device; and
updating one or more storage device schemas in the storage device.

7. The method of claim 1 wherein the step of capturing further includes:
defining one or more interrelated objects for the visual models; and
constructing one or more high-level structure containing one or more formulas to represent the application logic.

8. The method of claim 7 wherein the step of defining further includes, for each object, defining at least one object type, attribute, relationship to at least one other object, and expected behavior.

9. A method for developing and executing software applications at an abstract design level, the method comprising:
capturing an application logic at the abstract design level as one or more visual models for developing a software application, the visual models being independent from an underlying programming technology;
deploying the captured application logic to an execution platform;
generating one or more storage device schemas in at least one storage device as required by the captured application logic;
executing the application logic from the execution platform in response to an external request sent by an external client device, the external request having one or more parameters;
converting the parameters of the external request to one or more objects;
processing the external request;
returning one or more response objects after processing the external request;
converting the response objects to a predetermined format based on the type of the external client device or the parameters of the external request; and
presenting the converted response objects to the external client device.

10. The method of claim 9 wherein the step of processing the external request further includes passing the converted parameters to the application logic.

11. The method of claim 9 wherein the step of deploying further includes saving the captured application logic to the execution platform.

12. The method of claim 9 wherein the step of executing further includes:
retrieving one or more objects from the storage device; and
updating the storage device schemas.

13. The method of claim 9 wherein the step of capturing further includes:
defining one or more interrelated objects for the visual models; and
constructing one or more high-level structure containing one or more formulas to represent the application logic.

14. The method of claim 13 wherein the high-level structure is a process.

15. The method of claim 13 wherein the high-level structure is a rule.

16. The method of claim 13 wherein the step of defining further includes, for each object, defining at least one object type, attribute, relationship to at least one other object, and expected behavior.

17. A system for developing and executing software applications at an abstract design level, the system comprising:
a visual modeling tool for capturing an application logic at the abstract design level as one or more visual models for developing a software application, the visual models being independent from an underlying programming technology;
means for deploying the captured application logic to an execution platform;
means for executing the application logic from the execution platform in response to an external request sent by an external client device, the external request having one or more parameters;
means for processing the external request;
means for returning one or more response objects after processing the external request; and
means for presenting the converted response objects to the external client device.

18. The system of claim 17 wherein the means for processing further includes means for converting the parameters of the external request to one or more objects and passing the converted parameters to the application logic.

19. The system of claim 17 wherein the means for presenting further includes means for converting the response objects to a predetermined format based on the type of the external client device or the parameters of the external request.

20. The system of claim 17 wherein the means for capturing further includes generating one or more storage device schemas in at least one storage device as required by the captured application logic.

21. The system of claim 17 wherein the means for executing further includes means for:
retrieving one or more objects from at least one storage device; and
updating one or more storage device schemas in the storage device.

22. The system of claim 17 wherein the means for capturing further includes means:
defining one or more interrelated objects for the visual models; and
constructing one or more high-level structure containing one or more formulas to represent the application logic.

23. The system of claim 22 wherein the step of defining further includes, for each object, means for defining at least one object type, attribute, relationship to at least one other object, and expected behavior.
